(19) United States
(12) Patent Application Publication
(10) Pub. No.: US 2014/0174263 A1
(43) Pub. Date: Jun. 26, 2014

(54) CLEANABLE MAGNETIC DRIVER FOR THREADED FASTENERS

(71) Applicant: Black & Decker Inc., Newark, DE (US)

(72) Inventors: Darren B. MOSS, York, PA (US); Michael P. PETERS, Lutherville, MD (US); Mark E. BRUNSON, Bel Air, MD (US); Aland SANTAMARINA, Columbia, MD (US); Glen V. STEINBRUNNER, Bel Air, MD (US)

(73) Assignee: Black & Decker Inc., Newark, DE (US)

(21) Appl. No.: 14/191,534

(22) Filed: Feb. 27, 2014

Related U.S. Application Data
(63) Continuation-in-part of application No. 12/975,599, filed on Dec. 22, 2010, now Pat. No. 8,695,461.

(51) Int. Cl. B25B 23/12

(52) U.S. Cl. CPC B25B 23/12
USPC 81/125

(57) ABSTRACT

A driver for driving a threaded fastener includes a shank and a sleeve. The shank has a rear portion configured to be coupled to a power tool. The sleeve defines a bore having a round rear portion and a polygonal front socket. An inner shaft has a round rear portion received in the bore and a polygonal front portion that matches the polygonal socket and that includes a magnet holder with front and rear magnetic portions. An actuator is coupled to the inner shaft to move the inner shaft between a rear position where the front magnetic portion is within the socket, and a front position where the front magnetic portion is exposed from the socket for cleaning. The rear magnetic portion magnetically attracts the inner shaft toward a rear end of the internal bore to bias the inner shaft toward the rear position.

### CROSS REFERENCE TO RELATED APPLICATIONS

This application claims priority, under 35 U.S.C. §120, as a continuation-in-part of U.S. patent application Ser. No. 12/975,599, filed Dec. 22, 2010, titled “Cleanable Magnetic Nut Driver,” which application is incorporated herein by reference.

### TECHNICAL FIELD

The present disclosure relates to drivers for threaded fasteners, and more particularly, to a cleanable magnetic driver for threaded fasteners having polygonal outer shapes, such as nuts and hex head screws.

### BACKGROUND

This section provides background information related to the present disclosure which is not necessarily prior art.

Magnetic drivers have been available for use with drill drivers and other power tools. The drivers are used for driving fasteners, e.g., nuts and screws having a polygonal-shaped, e.g., hex-shaped head. The use of the driver is far more convenient than the use of wrenches or sockets that are hand driven. With the improved capability of installing screws at a rapid rate, the accumulation of metal chips within the magnetic driver can prohibit a proper receipt of a screw head in the driver.

### SUMMARY

This section provides a general summary of the disclosure, and is not a comprehensive disclosure of its full scope or all of its features.

The present disclosure provides a cleanable magnetic driver that allows the removal of metal chips from the magnet within the driver. According to one embodiment, a driver is provided including a shank having a rear portion configured to be coupled to a power tool. An intermediate portion defines an internal bore and a front portion defines a hex shaped socket in communication with the bore. A shaft is received in the bore and has a magnetic front portion. The shaft is slidable between a rearward position where the magnetic portion is disposed rearward of the socket, and a frontward position where the magnetic portion is exposed from the socket for cleaning. An actuator is provided external to the shank and fixably coupled to the shaft through a slot in a sidewall of the intermediate portion of the shank. The actuator is movable between a first position in which the actuator causes the shaft to move to the rearward position, and a second position in which the actuator causes the shaft to move to the frontward position for exposing the magnet for cleaning.

According to an alternative embodiment, a cleanable magnetic driver is provided including a shank having a rear portion configured to be coupled to a power tool and having a front magnetic portion. A sleeve is received over the shank and has a front portion defining a hex-shaped socket. A rear portion defines a bore in communication with the socket and which is received over the front magnetic portion of the shank. An actuator, external to the sleeve, is configured to prevent movement of the sleeve relative to the shank when not actuated, and is configured to enable movement of the sleeve relative to the shank when actuated. When the actuator is actuated, the sleeve is movable between a frontward position where the front magnetic portion is disposed rearward of the socket, and a rearward position where the magnetic portion is exposed from the socket for cleaning.

According to a still further alternative embodiment, a cleanable magnetic driver is provided including a shank having a rear portion configured to be coupled to a power tool and front magnetic portion. A driving portion includes a plurality of sleeves, each defining a bore and a hex-shaped socket forward of the bore, each hex-shaped socket having a different size. The driving portion is attachable to the shank in a plurality of orientations corresponding to the number of sleeves, such that in each orientation, the front magnetic portion is received inside the bore of one of the sleeves with the magnetic portion disposed rearward of the socket. The driving portion is removable from the shank to expose the magnetic portion for cleaning.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a perspective view of a cleanable magnetic driver according to the principles of the present disclosure;

FIG. 2 is a cross-sectional view of the cleanable magnetic driver shown in FIG. 1 with the shaft having a magnetic front portion which is fully received within the bore;

FIG. 3 is a cross-sectional view of the cleanable magnetic driver shown in FIG. 1, with the shaft having a magnetic front portion extended so as to be exposed from the socket for cleaning;

FIG. 4 is a perspective view of a cleanable magnetic driver according to an alternative embodiment;

FIG. 5 is a cross-sectional view of the cleanable magnetic driver shown in FIG. 4 with the shaft having a magnetic front portion which is fully received within the bore;

FIG. 6 is a cross-sectional view of the cleanable magnetic driver shown in FIG. 4, with the shaft having a magnetic front portion extended so as to be exposed from the socket for cleaning;

FIG. 7 is a cross-sectional view of the cleanable magnetic driver shown in FIG. 4 taken from a different angle than FIG. 5, with the shaft having a magnetic front portion which is fully received within the bore;

FIG. 8 is a perspective view of a cleanable magnetic driver according to an alternative embodiment;

FIG. 9A is a plan view of the cleanable magnetic driver shown in FIG. 8, with the shaft having a magnetic front portion extended so as to be exposed from the socket for cleaning;

FIG. 10A is a cross-sectional view of the cleanable magnetic driver taken along lines 10A-10A of FIG. 9A, with the shaft having a magnetic front portion extended so as to be exposed from the socket for cleaning;

FIG. 11A is a cross-sectional view of the cleanable magnetic driver taken along lines 10A-10A of FIG. 9A, with the shaft having a magnetic front portion which is fully received within the bore;

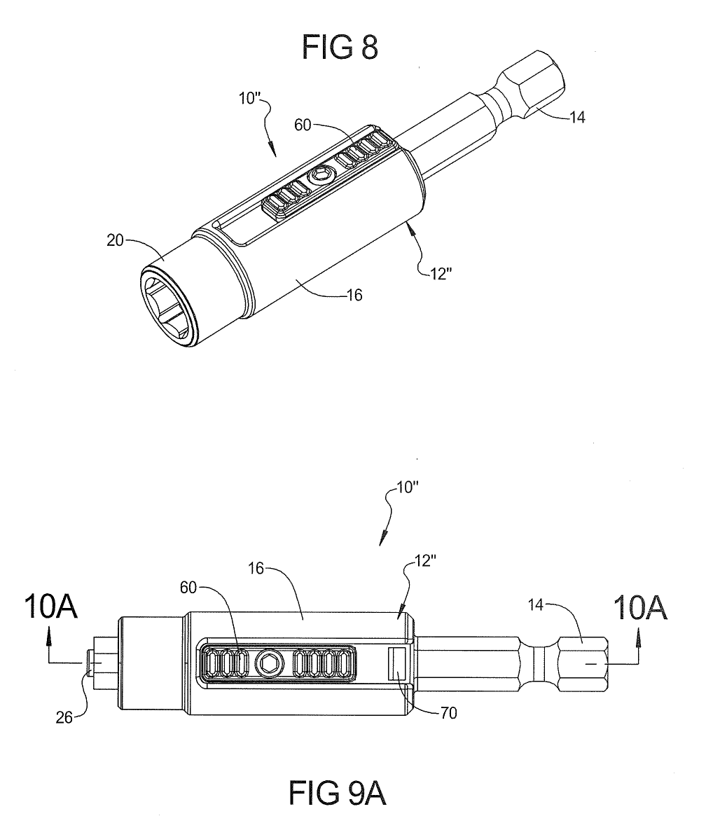

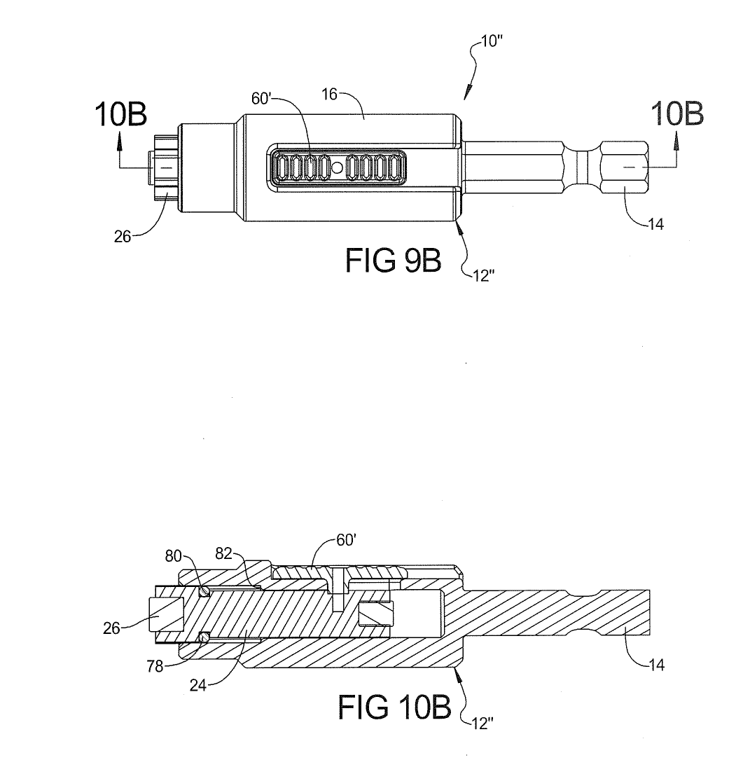

FIG. 9B is a plan view of the cleanable magnetic driver shown in FIG. 8, with the shaft having a magnetic front portion extended so as to be exposed from the socket for cleaning according to an alternative embodiment;

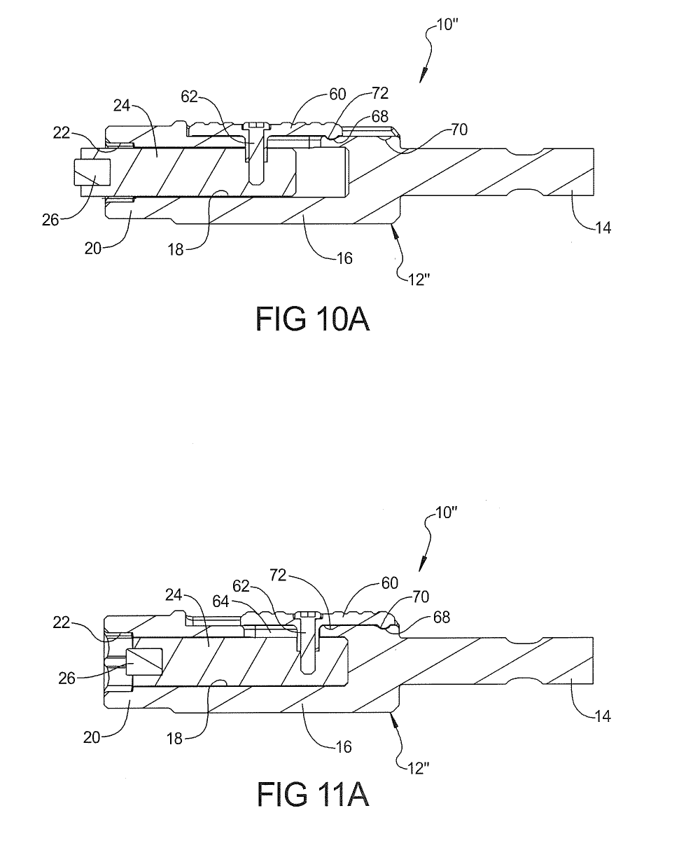

FIG. 10B is a cross-sectional view of the cleanable magnetic driver taken along lines 10B-10B of FIG. 9B, with the shaft having a magnetic front portion extended so as to be exposed from the socket for cleaning;

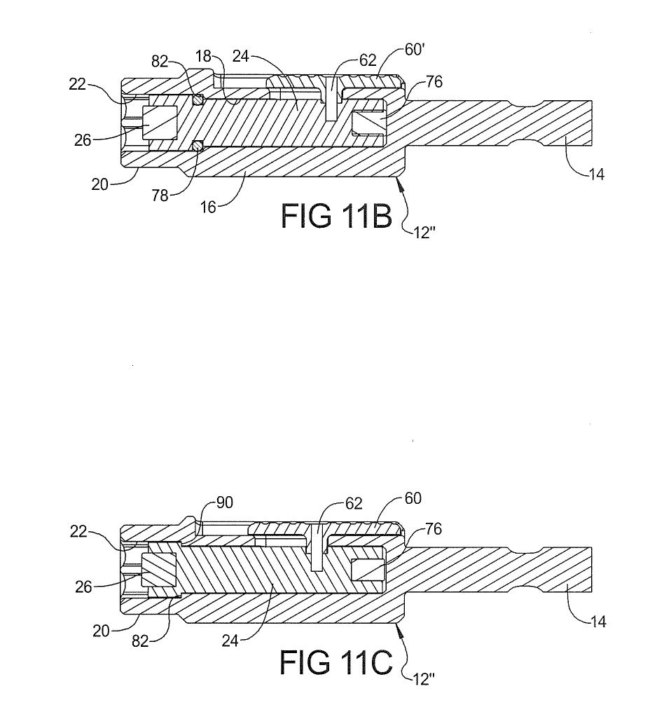

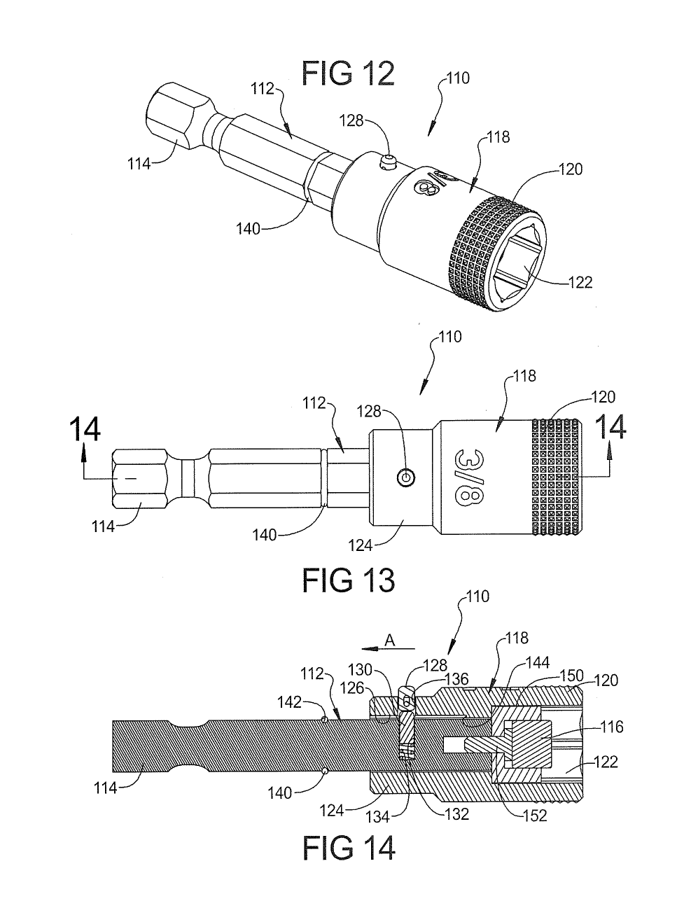

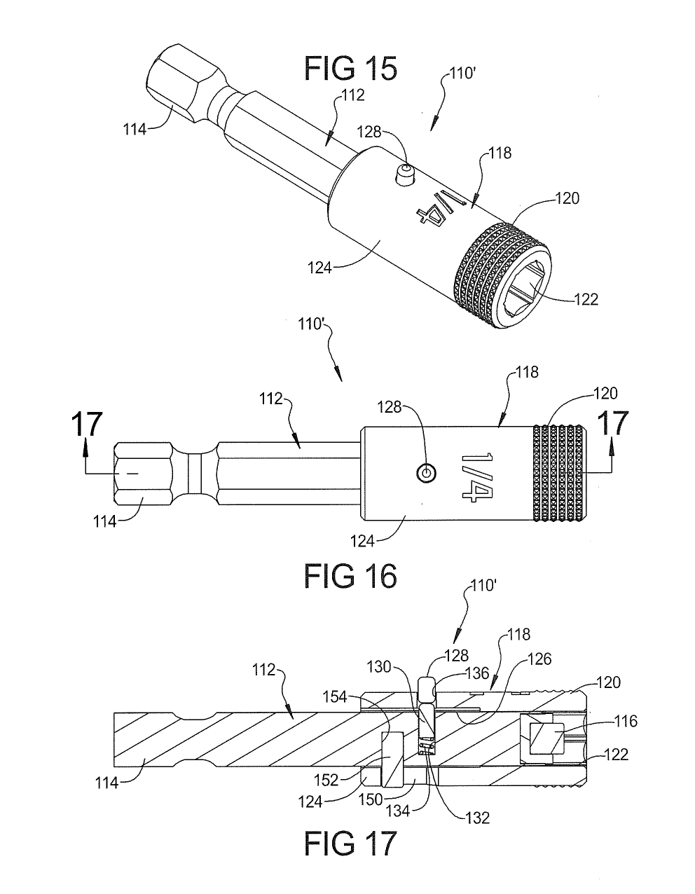

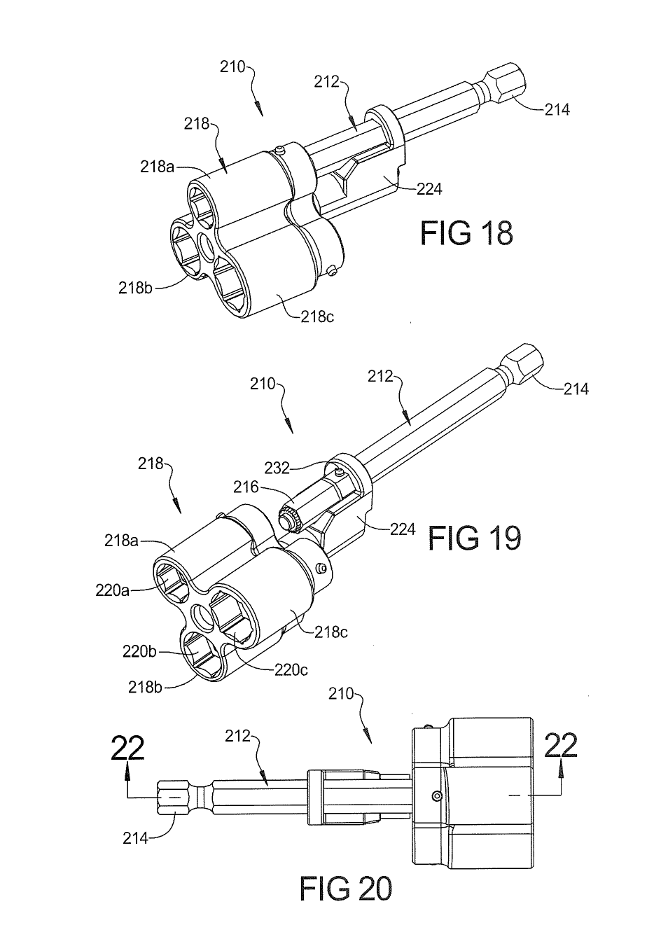

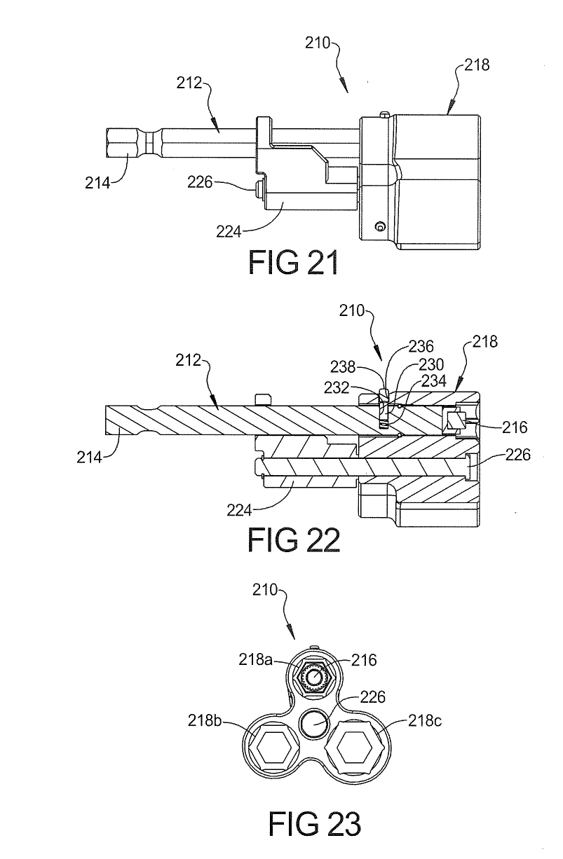

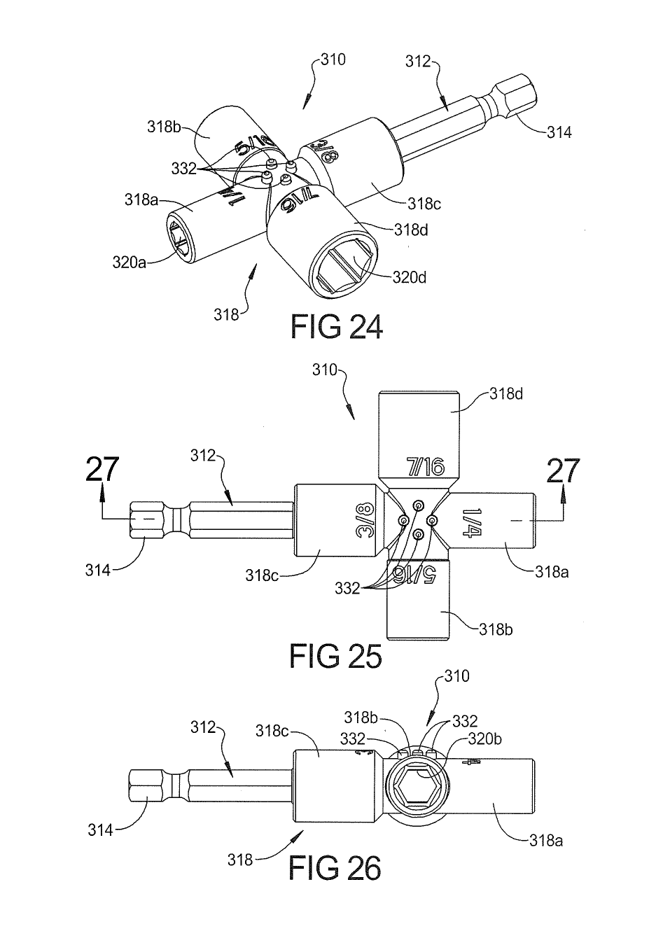

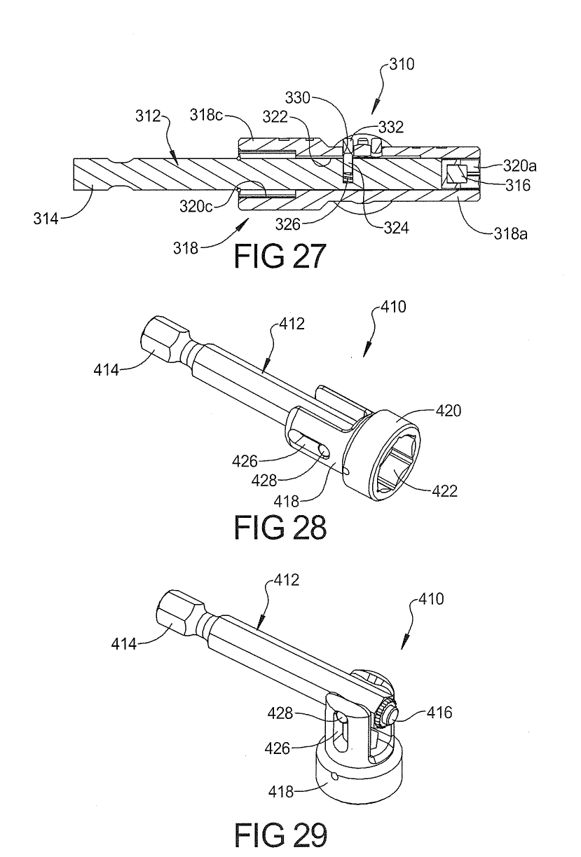

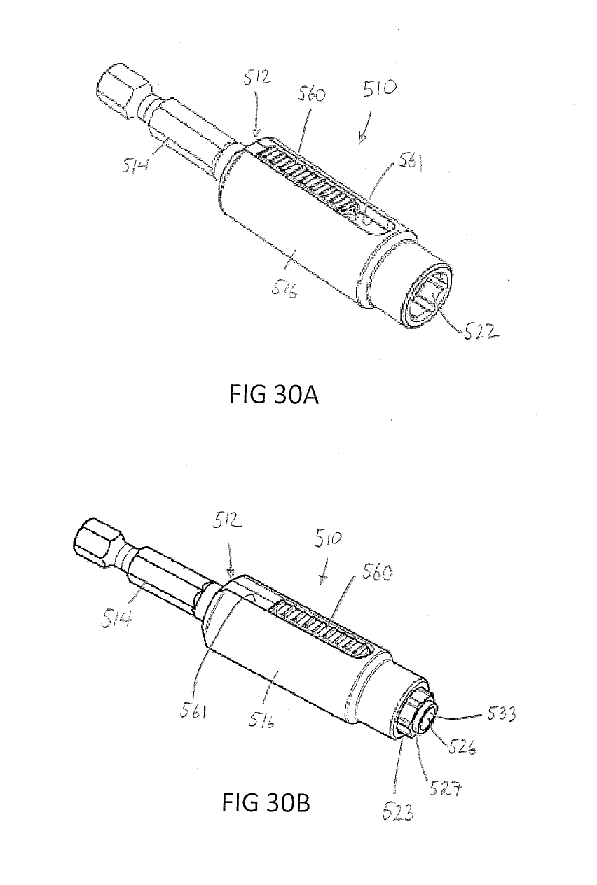

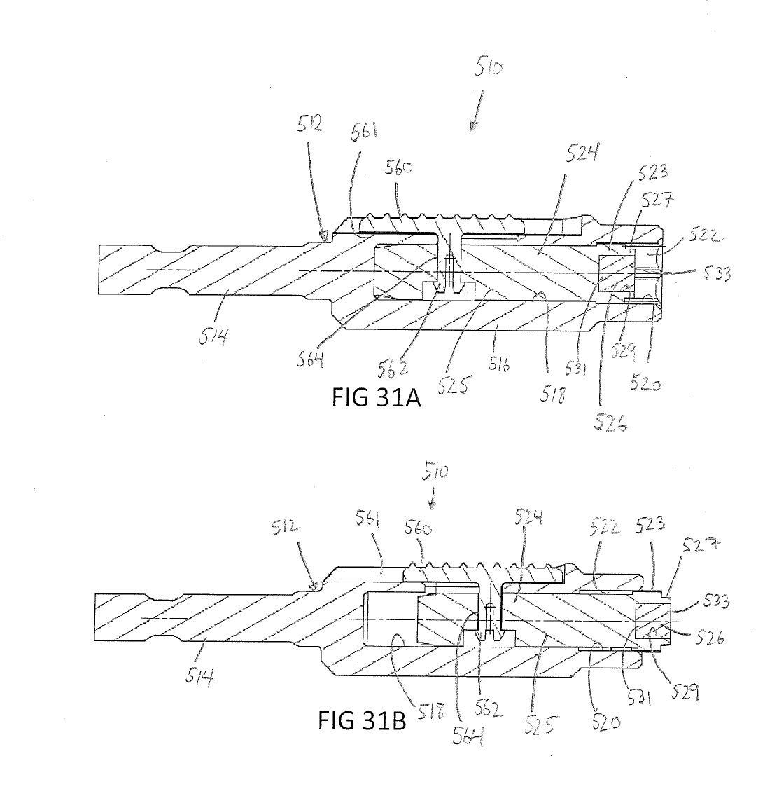

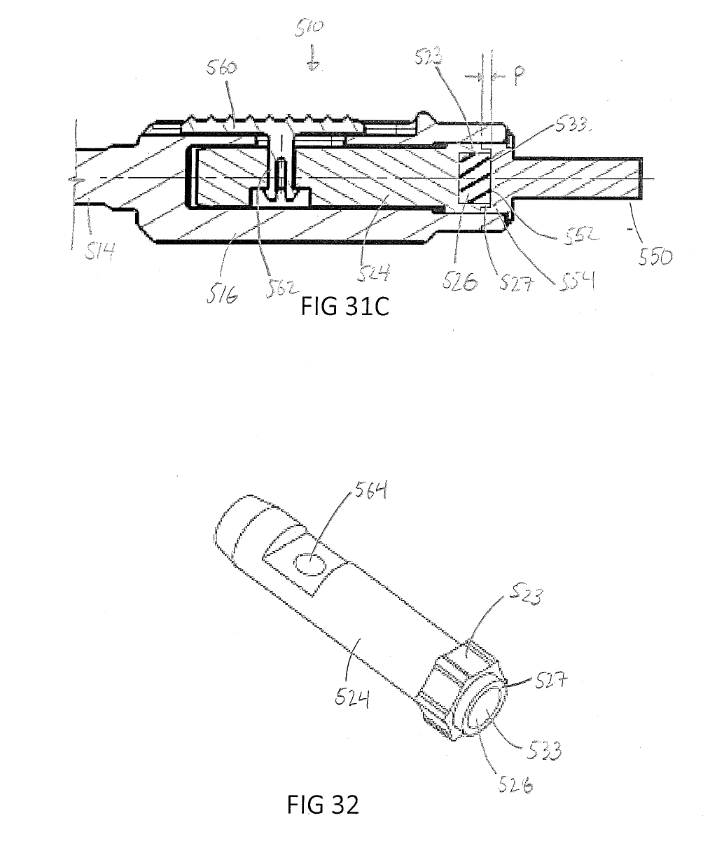

FIG. 11B is a cross-sectional view of the cleanable magnetic driver taken along lines 10-10 of FIG. 9B, with the shaft having a magnetic front portion which is fully received within the bore;

FIG. 11C is a cross-sectional view of the cleanable magnetic driver, with the shaft having a magnetic front portion which is fully received within the bore according to an alternative embodiment;

FIG. 12 is a perspective view of a cleanable magnetic driver according to an alternative embodiment;

FIG. 13 is a plan view of the cleanable magnetic driver shown in FIG. 12;

FIG. 14 is a cross-sectional view of the cleanable magnetic driver taken along lines 14-14 of FIG. 13;

FIG. 15 is a perspective view of a cleanable magnetic driver according to a further embodiment;

FIG. 16 is a plan view of the cleanable magnetic driver shown in FIG. 15;

FIG. 17 is a cross-sectional view of the cleanable magnetic driver taken along line 17-17 of FIG. 16;

FIG. 18 is a perspective view of a three-size cleanable driver according an alternative embodiment;

FIG. 19 is a perspective view of the three-size cleanable magnetic driver shown with the magnet exposed for removal of metal chips;

FIG. 20 is a plan view of the three-size cleanable magnetic driver shown in FIGS. 18 and 19;

FIG. 21 is a side-plan view of the three-size cleanable magnetic driver shown in FIGS. 18 and 19;

FIG. 22 is a cross-sectional view of the three-size cleanable magnetic driver taken along line 22-22 of FIG. 20;

FIG. 23 is an end-plan view of the three-size cleanable magnetic driver shown in FIGS. 18 and 19;

FIG. 24 is a perspective view of a four-size cleanable magnetic driver according to the principles of the present disclosure;

FIG. 25 is a top-plan view of the four-size cleanable magnetic driver shown in FIG. 24;

FIG. 26 is a side-plan view of the four-size cleanable magnetic driver shown in FIG. 24;

FIG. 27 is a cross-sectional view of the four-size cleanable magnetic driver taken along line 27-27 of FIG. 25;

FIG. 28 is a perspective view of a cleanable magnetic driver according to an alternative embodiment of the present disclosure; and

FIG. 29 is a perspective view of the cleanable magnetic driver shown in FIG. 28 with the pivoting sleeve moved to a downward position to expose the magnet for cleaning.

FIGS. 30A and 30B are perspective views of another embodiment of a cleanable magnetic driver for driving threaded fasteners.

FIGS. 31A and 31B are cross-sectional views of the driver of FIGS. 30A and 30B.

FIG. 31C is a close-up cross-sectional view of the driver of FIGS. 30A and 30B coupled to a threaded fastener with a polygonal head.

FIG. 32 is a perspective view of an inner shaft of the driver of FIGS. 30A and 30B.

Corresponding reference numerals indicate corresponding parts throughout the several views of the drawings.

### DETAILED DESCRIPTION

Example embodiments will now be described more fully with reference to the accompanying drawings.

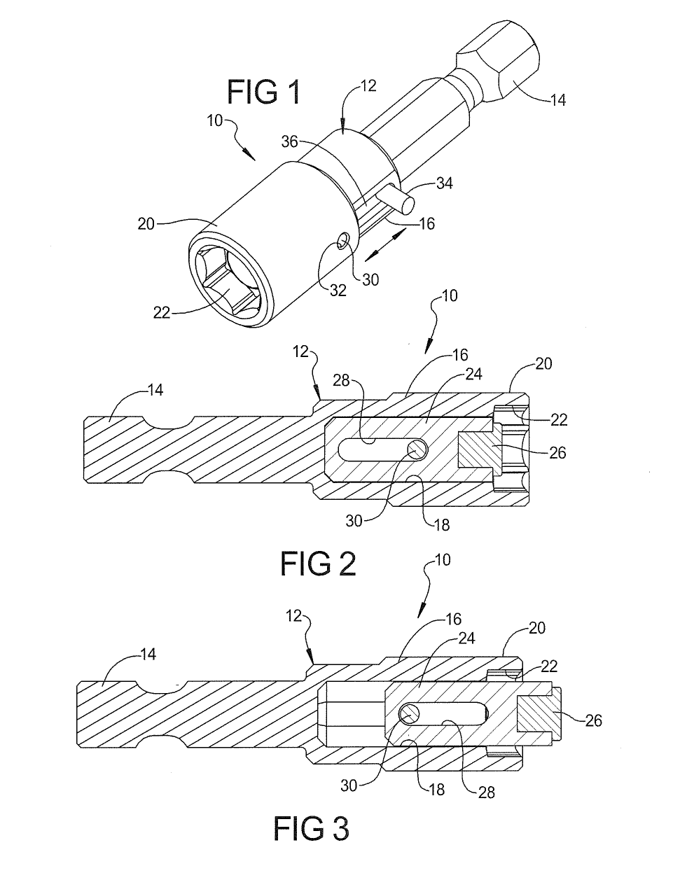

With reference to FIGS. 1-3, a cleanable magnetic driver 10 according to the principles of the present disclosure will now be described.

The cleanable magnetic driver 10 includes a shank 12 having a rear portion 14 configured to be coupled to a power tool. The shank includes an intermediate portion 16 defining an internal bore 18. The shank 12 also includes a front portion 20 defining a hex-shaped socket 22 in communication with the bore 18.

A magnet holder 24 is received in the bore 18 and includes a magnetic front portion 26. The magnet holder 24 is slidable between a rearward position, as shown in FIG. 2, where the magnetic front portion 26 is at a rearward end of the socket 22 and a forward position, as shown in FIG. 3, where the magnetic front portion 26 is exposed from the socket 22 for cleaning. The magnet holder 24 can include an elongated slot 28 extending transversely therethrough that receives a retaining pin 30 that limits the axial movement of the magnet holder 24 within the bore 18. The retaining pin 30 can be received in opposing apertures 32 provided in the wall of the intermediate portion 16 of the shank 12.

An actuator 34 can extend external to the shank 12 through an elongated slot 36 provided in the wall of the intermediate portion 16 of the shank 12. The actuator 34 is fixedly coupled to the magnet holder 24. The actuator 34 is movable between a first position in which the magnet holder 24 is moved to the rearward position as illustrated in FIG. 2 so that the magnet holder is fully retracted within the bore 18. The actuator is movable to a second position, as illustrated in FIG. 3, to move the magnet holder 24 to the frontward position where the magnetic front portion 26 is exposed for cleaning. A retaining mechanism such as a detent can be provided along the slot 36 in the shank or can otherwise be provided on the actuator 34 for releasably holding the actuator in either the first position or the second position. It is anticipated, that other alternative retaining mechanisms could be used.

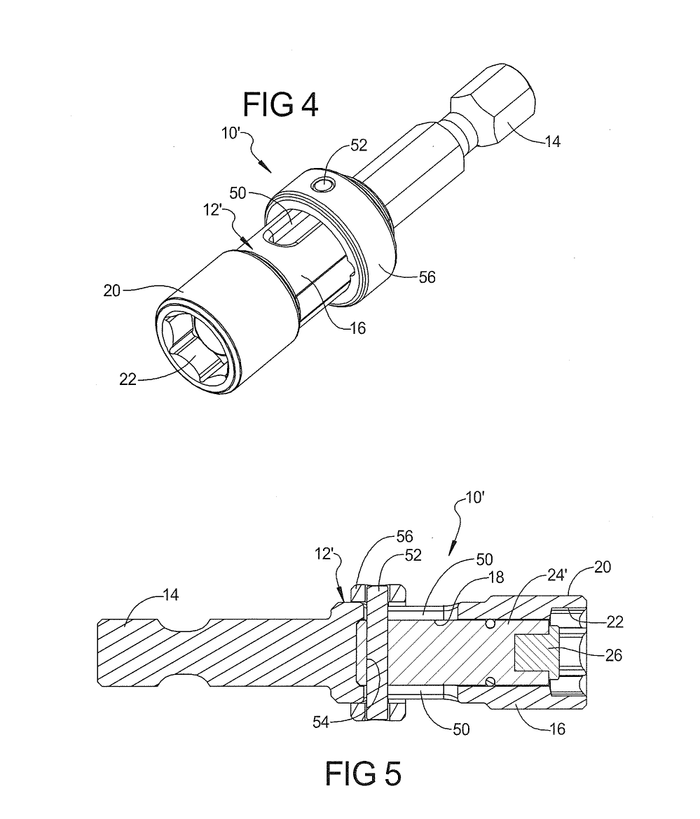

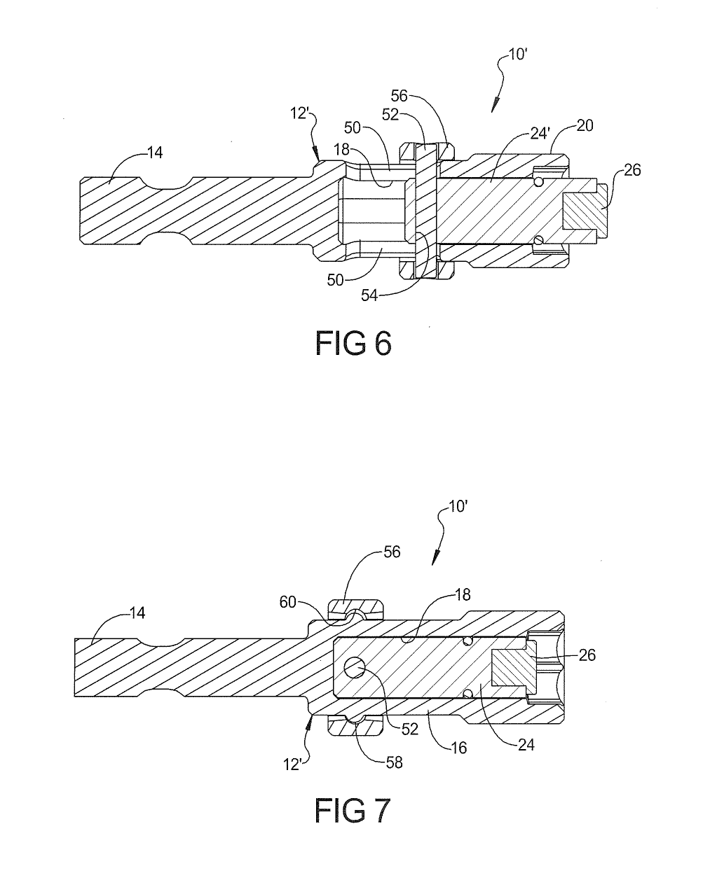

With reference to FIGS. 4-7, a cleanable magnetic 10′ according to an alternative embodiment will now be described. The cleanable magnetic driver 10′ includes a shank 12′ having a rear portion 14 configured to be coupled to a power tool and an intermediate portion 16 defining an internal bore 18 and a front portion 20 defining a hex-shaped socket 22 in communication with the bore 18. A magnet holder 24′ is slidably received in the bore 18 of the intermediate portion 16 and includes a magnetic front portion 26. The intermediate portion 16 includes a pair of axially extending slots 50 communicating with the bore 18 and receiving a transverse pin 52 through each slot 50. The transverse pin 52 is received in an aperture 54 extending through the magnet holder 24′ at a rear end thereof. A slide collar 56 can receive the transverse pin 52 and serves as an actuator for allowing the user to slide the magnet holder 24′ from a rearward use position as illustrated in FIG. 5 to a forward cleaning position as illustrated in FIG. 6. The shank 12′ can be provided with a detent 58 on a surface thereof for engaging with a recess 60 on an interior surface of the collar 56 in order to retain the magnet holder 24′ in the rearward position, as illustrated in FIG. 7. Additional detents could also be utilized for retaining the magnet holder 24′ in the forward position, if desired.

With reference to FIGS. 8 and 9A-11A, a cleanable magnetic driver 10″ according an alternative embodiment will now be described. The cleanable magnetic driver 10″ includes a shank 12″ having a rear portion 14 configured to be coupled to a power tool. An intermediate portion 16 defines an internal bore 18 and a front portion 20 defines a hex-shaped socket 22 in communication with the bore 18. A magnet holder 24 is received in the bore 18 and includes a magnetic front portion 26. The magnet holder is slidable between a rearward position, as best illustrated in FIG. 11, wherein the magnetic front portion 26 is disposed rearward of the socket 22 and a forward position, best shown in FIG. 10 where the magnetic front portion 26 is exposed from the socket 22 for cleaning. An actuator plate 60 is disposed external to the shank 12″ and is fixedly coupled to the magnet holder 24 via a post 62 that extends through a longitudinal slot 64 in the sidewall of the intermediate portion 16 of the shank 12″. The actuator plate 60 allows a user to slide the actuator plate 60 to cause the magnet holder 24 to move from its rearward and forward positions. The plate 60 can include a detent 68, shown in its rearward end that can be received within one of the recesses 70, 72 provided in the surface of the intermediate portion 16 of the shank 12′. The recesses 70, 72 are provided at axially spaced rearward and forward positions in order to retain the plate 60 and magnet holder 24 in either of its rearward or forward positions, respectively.

As illustrated in FIGS. 9B-11B, the detent 68 on the actuator plate 60 and the recesses 70, 72 on the shank 12″ can be eliminated and replaced with a magnet 76 disposed on a rear end of the magnet holder 24. The magnet 76 is attracted to the rearward end of the bore 18 and helps to maintain the magnet holder 24 in a rearward position during use. An O-ring 78 can also be utilized in a recess 80 surrounding the magnet holder 24. The O-ring provides a tight engagement with the inner walls of the hexagonal socket 22 to prevent contaminants from entering the bore 18. The O-ring 78 also provides resistance to free movement of the magnet holder 24 within the bore 18. The O-ring 78 can seat against a shoulder 82 where the socket portion 22 transitions to the bore 18. As seen in FIG. 11C, the O-ring can be eliminated and the magnet holder 24′ can be provided with a rearward facing shoulder 90 that seats against the forward facing shoulder 82 to help prevent contaminants from entering the bore 18.

With reference to FIGS. 12-14, a cleanable magnetic driver 110 according to an alternative embodiment will now be described. The cleanable magnetic driver 110 includes a shank 112 having a rear portion 114 configured to be coupled to a power tool and a front magnetic portion 116, best shown in the cross-sectional view of FIG. 14. A sleeve 118 is received over the shank 112 and includes a front portion 120 defining a hex-shaped socket 122 and a rear portion 124 defining a bore 126 in communication with the socket 122 and received over the front magnetic portion 126 of the shank 112. An actuator 128 extends external to the sleeve 118 and is configured to prevent movement of the sleeve 118 relative to the shank 112 when not actuated. The actuator 128 is configured to enable movement of the sleeve 118 relative to the shank 112 when actuated. The actuator can include a release pin 128 that is adapted to engage a lateral travel pin 130 that is received in a bore 132 in the shank 112. The lateral travel pin 130 is biased by a spring 134 so as to provide engagement with the bore 136 that receives the release pin 128 when the bore 136 is aligned with the lateral travel pin 130. By pressing the release pin 128, the user can disengage the lateral travel pin 130 from engagement with the bore 136 in the sleeve 118 to allow the sleeve 118 to move to a rearward position as illustrated by arrow A so that the front magnetic portion 116 can be exposed for cleaning. A c-clip or o-ring 140 can be provided in a recessed groove 142 provided in the shank 112 for engaging an interior shoulder 144 disposed within the bore 126 of the sleeve 118 to provide a limit on the rearward motion on the sleeve 118. The limited axial motion of the sleeve 118 is sufficient to allow exposure of the front magnetic portion 116 to allow the magnetic portion 116 to be cleaned. The sleeve 118 is then moved to a forward position wherein the lateral travel pin 130 is aligned with the bore 136 for retaining the sleeve 118 in its forward, use position. As illustrated in FIG. 14, the forward magnetic portion 116 can be secured to the shank 112 by a cup-shaped housing 150 and post 152 which are used to secure the magnet 116 to the shank 112. Alternative methods of fastening the magnet 116 to the shank 112 can also be utilized.

With reference to FIGS. 15-17, a cleanable magnetic driver 110′ according to an alternative embodiment will now be described. The cleanable magnetic driver 110′ includes a shank 112 having a rear portion 114 configured to be coupled to a power tool and a front magnetic portion 116, as best shown in FIG. 17. A sleeve 118 is received over the shank 112. The sleeve has a front portion 120 defining a hex-shaped socket 122. A rear portion 124 of the sleeve 118 defines a bore 126 in communication with the socket 122 and received over the front magnetic portion 116 of the shank 112. An actuator 128 in the form of a release pin 128 can engage a lateral travel pin 130 that is received in a lateral bore 132 of the shank 112. A biasing spring 134 is provided in the bore 132 for biasing the lateral travel pin 130 in a radially outward direction. The lateral travel pin 130 can be received in a bore 136 that receives the release pin 128 for retaining the sleeve 118 in a fixed forward position as illustrated in FIG. 17. The sleeve 118 can include an elongated slot 150 for receiving a guide pin 152 that is received in a bore 154 in the shank 112. The guide pin 152 engages the slot 150 in order to limit the axial travel of the sleeve 118 from its forward position to a rearward position that allows the front magnetic portion 116 to be exposed for cleaning. In the embodiment of FIGS. 15-17, the guide pin 152 and axially extending slot 150 in sleeve 118 take the place of the retainer clip 140, shown in the embodiment of FIGS. 12-14, in limiting the axial movement of the sleeve 118.

With reference to FIGS. 18-23, a three-size cleanable magnetic driver 210 according to an alternative embodiment will now be described. The three-size cleanable magnetic driver 210 includes a shank 212 having a rear portion 214 configured to be coupled to a power tool and a front magnetic portion 216, as best illustrated in FIGS. 19 and 22. A socket assembly 218 includes a plurality of sockets 218a-218c each fixed together and each having a forward open end with different sized polygonal cavities 220a-220c. The socket assembly 218 is removably attached to the shank 212 in a plurality of positions so that the forward opened end of each of said plurality of sockets 218a-218c can be separately replaced in an operable position and axially aligned with the shank 212. The rear end portion of the each of the sockets 218a-218c includes a polygonal bore that mates with the shank 212 forward end so that the front magnetic portion 216 is disposed adjacent to the different sized polygonal cavities of each of the sockets 218a-218c. The socket assembly 218 can include a sleeve 224 that is slidably mounted on the shank 212 and the plurality of sockets 218a-218c are rotatably mounted to the sleeve 224 by a support shaft 226 as best shown in FIGS. 22 and 23.

The shank 212 can include a transverse bore 230 that receives a lateral travel pin 232 therein. A spring 234 can be provided in the bore 230 for biasing the lateral travel pin 232 to a radially outward position. Each of the sockets 218a-218c can be provided with a corresponding bore 236 that receives a release pin 238 therein. In the assembled position, the sockets 218a-218c are received on the forward end of the shank 212 until the bore 236 in each socket is aligned with the lateral travel pin 232 for retaining the socket 218a-218c to the shank 212. In order to remove each socket 218a-218c, the release pin 238 thereon is depressed thereby forcing the lateral travel pin 232 out of engagement with the bore 236 in the respective socket 218a-218c. Once the socket 218a-218c is removed from the shank, the magnetic front portion 216 is exposed and can be easily cleaned. The socket assembly 218 can then be rotated about the guide pin 226 to a desired location so that the socket 218a-218c can be fixed to the shank 212 for use. As illustrated in FIG. 19, the lateral travel pin 232 can serve as a stop surface for engaging the sleeve 224 to prevent the sleeve 224 from being removed from the shank 212. It is noted that for easy assembly of each of the sockets 218a-218c onto the shank 212, a rear beveled edge can be provided that would slidably engage the top of the lateral travel pin 232 to press the lateral travel pin radially inward as the socket 218a-218c is slid onto the shank 212 until the lateral travel pin engages the bore 236 in the respective socket 218a-218c. With the proposed design of FIGS. 18-23, the use of a plurality of different sized drivers can be utilized with the tool while also providing the capability of cleaning the magnet for efficient operation of the driver.

With reference to FIGS. 24-27, a four-size cleanable magnetic driver 310 will now be described. The four-size cleanable magnetic driver 310 includes a shank 312 having a rear portion 314 configured to be coupled to a power tool and front magnetic portion 316, as best shown in FIG. 27. A socket portion 318 includes a plurality of different sized sockets 318a-318d each defining a bore and a hex-shaped socket forward of the bore, each socket having a different size. The socket assembly 318 is removably attached to the shank 312 in a plurality of positions so that the forward open end of each of said plurality of sockets 318a-318d can be separately placed in an operable position axially aligned with the shank 312. Each of the different sized polygonal cavities 320a-320d of each of the sockets 318a-318d communicates with a polygonal bore that mates with the shank 312.

The shank 312 can include a lateral travel pin 324 received in a lateral bore 326 that is biased in an outward direction by a spring (not shown). The lateral travel pin 324 can be aligned with and received in a corresponding bore 330 provided in association with each of the sockets 318a-318d in each of the bores 330, a release pin 332 is provided for disengaging the lateral travel pin 324 from the socket assembly 318 to allow the socket assembly to be removed from the shank 312. When the socket assembly 318 is removed from the shank 312, the front magnetic portion 316 is exposed and can be easily cleaned. The socket assembly 318 can then be properly oriented onto the shank 312 so that the selected socket size can be utilized. With the tool 310 as shown, the use of four different sized sockets can be utilized with a single shank while the sockets can be removable to allow easy cleaning of the magnet for more efficient use of the driver.

With reference to FIGS. 28 and 29, a cleanable magnetic driver 410 according to an alternative embodiment will now be described. Cleanable magnetic driver 410 includes a shank 412 having a rear portion 414 configured to be coupled to a power tool and a front magnetic portion 416, as best shown in FIG. 29. A sleeve 418 is received over the shank 412 and includes a front portion 420 defining a hex-shaped socket 422 and a rear portion defining a bore in communication with the socket and received over the front magnetic portion of the shank 412. The sleeve 418 includes a pair of elongated longitudinally extending slots 426 disposed on opposite sides thereof for receiving a guide pin 428 extending laterally from opposite sides of the shank 412. In its operating position, the sleeve 418 is slid over the shank 412 so that the hex-shaped socket 422 is axially aligned with the shank 412 and the guide pin 426 is received at a forward end of the elongated slot 426. In order to clean the front magnetic portion 416 of the shank 412, the sleeve 418 can be slid in a forward direction so that the guide pin 428 is received at a rearward end of the elongated slots 426 and the sleeve 418 can be pivoted about the guide pin 428 away from the front magnetic portion 416 so that the front magnetic portion 416 is exposed and can be cleaned. In order to resume use of the cleanable magnetic driver 410, the sleeve 418 is then pivoted about the guide pin 428 such that the hex-shaped socket 422 is axially aligned with the shank 412 and the sleeve 418 is slid rearwardly onto the shank 412.

With reference to FIGS. 30A-32, a cleanable magnetic driver 510 for threaded fasteners with polygonal outer geometry according another alternative embodiment will now be described. The cleanable magnetic driver 510 includes an outer shaft 512 having a rear shank 514 configured to be coupled to a power tool and a front sleeve 516. The front sleeve 516 defines an internal bore 518 having a round rear portion 519 and a front polygonal (e.g. hex shaped) portion 520 that defines a socket 522 in communication with the rear portion 519 of the bore 518.

An inner shaft 524 includes a round rear portion 525 received in the rear portion 519 of the bore 518, and a polygonal (e.g., hex shaped) magnet holder portion 523 received in the polygonal portion 520 of the bore 519, and a rim 527 extending forward of the magnet holder portion 524. The magnet holder portion 524 has the same polygonal shape as the socket 522, which prevents dust and other contaminants from entering the bore 518. In other embodiments a seal, such as an O-ring (similar to the O-ring 80 shown in FIG. 10B) may be used to prevent contamination and help push metal shavings out of the bore 518. The magnet holder portion 524 and rim 527 together define a recess 529 that receives a magnet 526. The magnet 526 has a rear magnetic portion 531 and a front magnetic portion 533 that is flush with the rim 527. The inner shaft 524 is moveable between a rearward position, as best illustrated in FIGS. 30A and 31A, where the magnetic front portion 533 is disposed within the socket 522, and a forward position, best shown in FIGS. 30B and 31B, where the magnetic front portion 533 is exposed from the socket 522 for cleaning.

An actuator plate 560 is disposed in a longitudinal recess 561 defined in an outer wall of the sleeve portion 516. The actuator plate 560 is fixedly coupled to the round portion 525 of the inner shaft 524 via a post 562 that extends through a cross-bore 564 defined through the round portion 525 of the inner shaft 524. The post 562 comprises a pair of legs with a bulbous end portion that can be press fit into the cross bore 564. A user can slide the actuator plate 560 to cause the inner shaft 524 to move from its rearward position to its forward position for cleaning.

The inner shaft 524 is composed of a non-ferromagnetic material (e.g., non-magnetic stainless steel), while the sleeve 516 and shank 514 are composed of a ferromagnetic material (e.g., 50CrVa steel or 6150 steel). When the inner shaft 524 is in its forward position, the rear portion 531 of the magnet 526 attracts the magnet holder portion 523, and thus the entire inner shaft 524, toward a rear end of bore 518 via an attractive magnetic force between the rear portion 531 of the magnet 526 and the ferromagnetic sleeve 516 and shank 512. In this manner, the inner shaft 524 appears to be biased toward the rearward position, without the use of any springs or secondary magnets. This arrangement simplifies the construction and reduces the cost of the driver 510.

Referring in particular to FIGS. 31C and 32, the rim 527 of the inner shaft 524 and the front magnetic portion 533 of the magnet 526 stand proud of the polygonal magnet holder portion 523 by a small distance P, e.g., by approximately 1.0 to 1.5 mm. This allows the rim 528 and front magnetic portion 533 to be received in a socket or hole in a threaded fastener. For example, as shown in FIG. 31C, the rim 527 and front magnetic portion 533 are received in a round socket 552 in a hex head 554 of a threaded screw 550. This arrangement also allows the front magnetic portion 533, and thus the entire inner shaft 524 to jump forward to engage the head of the threaded fastener. In an alternative embodiment, the rim could be eliminated, and the front portion of the magnet could stand proud of the magnet holder portion 523.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A driver for driving a threaded fastener, the driver comprising:
an outer shaft having a shank and a sleeve, the shank having a rear portion configured to be coupled to a power tool, and the sleeve defining an internal bore having a round rear portion and a polygonal front socket that matches a polygonal outer geometry of a threaded fastener;
an inner shaft having a round rear portion received in the internal bore and a polygonal front end portion that matches the polygonal socket, the front end portion including a magnet holder having a front magnetic portion and a rear magnetic portion; and
an actuator fixedly coupled to the inner shaft so that the actuator and the inner shaft are moveable between a rear position in which the front magnetic portion is disposed within the socket, and a front position where the front magnetic portion is exposed from the socket for cleaning;
wherein the rear magnetic portion magnetically attracts the inner shaft toward a rear end of the internal bore to bias the inner shaft toward the rear position.

2. The driver of claim 1, wherein the magnet holder is biased toward the rear position independent of a spring force.

3. The driver of claim 1, wherein the magnet holder comprises a single magnet coupled to the front end portion of the inner shaft, the single magnet having the front magnetic portion and the rear magnetic portion.

4. The driver of claim 1, wherein the socket comprises a hexagonal inner geometry.

5. The driver of claim 4, wherein the front end portion of the inner shaft comprises a hexagonal outer geometry that matches the hexagonal inner geometry.

6. The tool of claim 1, wherein the front magnetic portion further comprises a round portion that stands proud forward of the polygonal outer geometry, the round portion configured to jump forward to engage a recess in a threaded fastener.

7. The tool of claim 1, wherein the inner shaft is composed of a non-ferromagnetic material and the sleeve is composed of a ferromagnetic material so that the rear magnetic portion is magnetically attracted to the sleeve.

8. The tool of claim 1, wherein the actuator comprises a longitudinally extending switch coupled to the inner shaft and received in a longitudinal slot in the sleeve.

9. The tool of claim 1, wherein the rear portion of the inner shaft includes a second magnetic portion configured to attract the inner shaft toward the rear end of the internal bore.

10. A threaded fastener driving tool comprising:
a shank having a front end portion and a rear end portion configured to be coupled to a power tool;
a sleeve coupled to the front end portion of the shank, the sleeve defining an internal bore having a rear portion and a front socket for driving a threaded fastener;
an inner shaft having a rear portion received in the internal bore and a front portion with a magnet holder received in the socket, the magnet holder having a front magnetic portion and a rear magnetic portion, the shaft being moveable between a rear position in which the front magnetic portion is disposed within the socket, and a front position where the front magnetic portion is exposed from the socket for cleaning; and
an actuator coupled to at least one of the sleeve and the inner shaft to enable manual movement of the inner shaft between the rear position and the front position,
wherein the rear magnetic portion is magnetically attracted to the sleeve to bias the inner shaft toward the rear position.

11. The tool of claim 10, wherein the magnet holder is biased toward the rear position independent of a spring force.

12. The tool of claim 10, wherein the magnet holder comprises a single magnet coupled to the front end portion of the inner shaft, the single magnet having the front magnetic portion and the rear magnetic portion.

13. The tool of claim 10, wherein the socket comprises a polygonal inner geometry.

14. The tool of claim 13, wherein the front end portion of the inner shaft comprises a polygonal outer geometry that matches the polygonal inner geometry.

15. The tool of claim 14, wherein rear portion of the bore is round and the rear portion of the inner shaft is round.

16. The tool of claim 14, wherein the front magnetic portion further comprises a round portion that stands proud forward of the polygonal outer geometry, the round portion configured to jump forward to engage a recess in a threaded fastener.

17. The tool of claim 10, wherein the inner shaft is composed of a non-ferromagnetic material and the sleeve is composed of a ferromagnetic material so that the rear magnetic portion is magnetically attracted to the sleeve.

18. The tool of claim 10, wherein the actuator comprises a longitudinally extending switch coupled to the inner shaft and received in a longitudinal slot in the sleeve.

19. The tool of claim 10, wherein the rear portion of the inner shaft includes a second magnetic portion configured to attract the inner shaft toward the rear end of the internal bore.

20. A driver for driving a threaded fastener, the driver comprising:
an outer shaft having a shank and a sleeve, the shank having a front end portion and a rear end portion configured to be coupled to a power tool, and the sleeve coupled to the front end portion of the shank and defining an internal bore having a round rear portion and a front polygonal socket for driving a threaded fastener having a corresponding polygonal outer geometry;
an inner shaft having a round rear portion received in the internal bore and a front portion with a magnet holder received in the socket, the magnet holder coupled to a single magnet, the single magnet having a front magnetic portion and a rear magnetic portion, the inner shaft being moveable between a rear position in which the front magnetic portion is disposed within the socket, and a front position where the front magnetic portion is exposed from the socket for cleaning; and
an actuator an actuator fixedly coupled to the inner shaft and received in a longitudinal slot in the sleeve so that the actuator is configured to move between a first position in which the inner shaft is in the rear position and a second position in which the inner shaft is in the front position,
wherein the inner shaft is composed of a non-ferromagnetic material and the sleeve is composed of a ferromagnetic material so that the rear magnetic portion is magnetically attracted to the sleeve to bias the inner shaft toward the rear position, independent of a spring force.
